(19) United States
(12) Patent Application Publication
(10) Pub. No.: US 2008/0127909 A1
(43) Pub. Date: Jun. 5, 2008

(54) Dogs dropping collection and disposal device

(76) Inventors: Ino Albalas, Herzliya (IL); Daniel Mor, Herzliya (IL); Yacov Dayan, Herzliya (IL)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/634,791

(22) Filed: Dec. 5, 2006

(51) Int. Cl. A01K 23/00

(52) U.S. Cl. 119/868

(57) ABSTRACT

A portable dogs dropping collection and disposal device. A carrier member made of a yieldable sheet material is provided, parts of which being removed to define an opening as well as a pair of elongated flaps extending parallel to each other. A bag made of a foldable sheet material having a mouth portion is attached to one side of the carrier member around the said opening. A first sticky patch is carried at the free end of one of the said flaps, facing the side opposite to the bag. A second sticky patch is carried at the free end of the second flap facing the side opposite to the bag. A third sticky patch is carried at the free end of the second flap facing the side opposite to the second patch.

### FIELD OF THE INVENTION

This invention relates generally to devices for wrapping, picking up and removing animal excrement, and more particularly to an improved device for the proper disposal of dog droppings.

### BACKGROUND OF THE INVENTION

Because of the unsightly and unsanitary nature of dog droppings along sidewalks, boulevards and parks, most municipality authorities have enacted regulations requiring that pet owners must not only leash their dogs during walks, but are also requested to pick-up and remove their dog droppings deposited during the walk. Severe penalties were prescribed for the enforcement of these rules.

Numerous devices have been developed and launched to the marketplace, which facilitate both pick-up and removal of dog droppings. The simple and straightforward arrangement has been—and still is—the utilization of a plain plastic disposable bag or pouch. The dog's owner puts one hand into the bag in a glove fashion and picks-up the droppings. The holding of the bag is then reversed by turning it inside-out, closed, and carried to the nearest garbage bin. A significant psychological drawback is encountered when utilizing this well-known methodology, namely the need to physically contact, though indirectly, the soft, squishy droppings.

More sophisticated solutions have been proposed, among which: various designs of handle-operated pick-up scoopers; and waste disposal bag carriers associated and/or integrated with dog leashes. None of these prior art devices eliminated the necessity to attend to the actual handling, directly or indirectly, of the dog's excrement.

### OBJECTS OF THE INVENTION

It is therefore the prime object of the invention to confine the dog dropping removal operation merely to the carrying of a bag already containing the dropping, to the garbage bin.

It is a further object of the invention to provide a device, which is anatomically designed to be worn by the dog whenever taken for a walk to do its business.

### SUMMARY OF THE INVENTION

According to a general aspect of the invention there is provided a portable dogs dropping collection and disposal device comprising a carrier member made of a yieldable sheet material parts of which having been removed to define an opening as well as a pair of elongated flaps extending parallel to each other. A bag made of a foldable sheet material having a mouth portion being attached to one side of the carrier member around the said opening. A first sticky patch carried at the free end of one of the said flaps facing the side opposite to the bag. A second sticky patch carried at the free end of the second flap facing the side opposite to the bag.

A third sticky patch may be provided carried at the free end of the second flap facing the side opposite to the second patch.

### BRIEF DESCRIPTION OF THE DRAWINGS

These and additional constructional features and advantages of the invention will be more readily understood in the light of the ensuing description of a preferred embodiment thereof, given by way of example only, with reference to the accompanying drawings, wherein:

FIG. 1 is a rear perspective view of a device featuring the principles of the present invention;

FIG. 2 is a front perspective view of the device of FIG. 1;

FIG. 3 is a rear perspective view of the device of FIG. 1 illustrating the stage of peeling-off the sticky patches protective skin;

FIG. 4 illustrates the stage of preparing the device for dressing it over the dog's tail and against it's behind;

FIG. 5 shows a first stage of attaching the device to a dog;

FIG. 6 shows a second stage of attaching the device to the dog;

FIG. 7 shows the state of the dropping; and

FIG. 8 shows the device removed from the dog and carried away for disposal.

### DETAILED DESCRIPTION OF THE PREFERRED EMBODIMENT

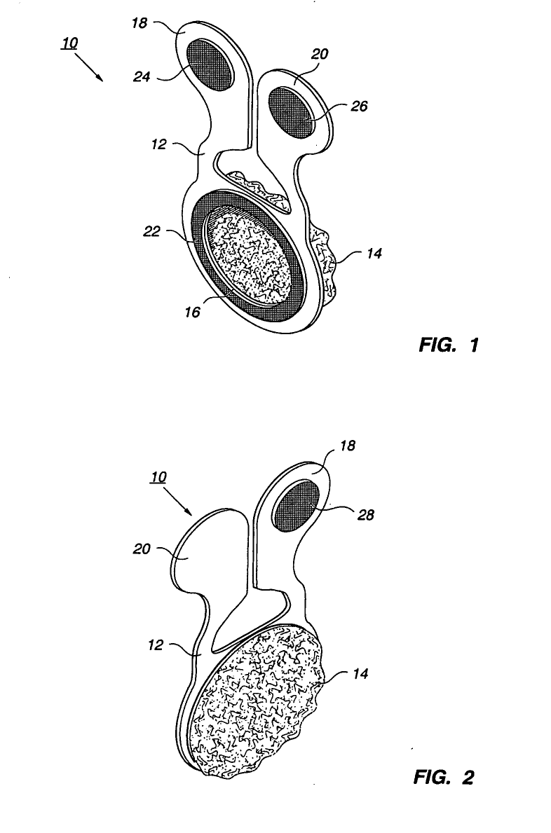

Referring to FIGS. 1-3, the dog dropping collecting device generally designated 10 comprises a carrier member 12 associated with bag 14.

The carrier member 12 is made of yieldable sheet material such as Polyethylene or Nylon. It is generally U-shaped wherein a circular opening 16 has been punched-out. It further comprises first and second flaps 18 and 20 extending parallel to each other.

The bag 14, typically made of thin Polyethylene, is glued or otherwise attached so that its open mouth fits around the opening 16. The bag is preferably crimped or folded into a flat, maximum space-saving state.

A plurality of sticky patches are attached to the carrier member in a manner to be described below. The term “sticky” as herein used should be construed as including all types of adhesive carrying substrates, as well as other surface attachable means, and in particular those known as “Velcro” or “Japanese scotch”.

The sticky patches are preferably covered by a peelable protective skin or layer as used, for example, in baby's diapers.

Hence, a circular ring-like sticky patch 22 is attached around the opening 16, opposite to the mounting side of the bag 14. A coin-shaped sticky patch 24 is attached to the flap 18. A coin-shaped sticky patch 26 is attached to the flap 20.

Another, coin-shaped sticky patch 28, may be attached to the other side of the flap 18, opposite the patch 24.

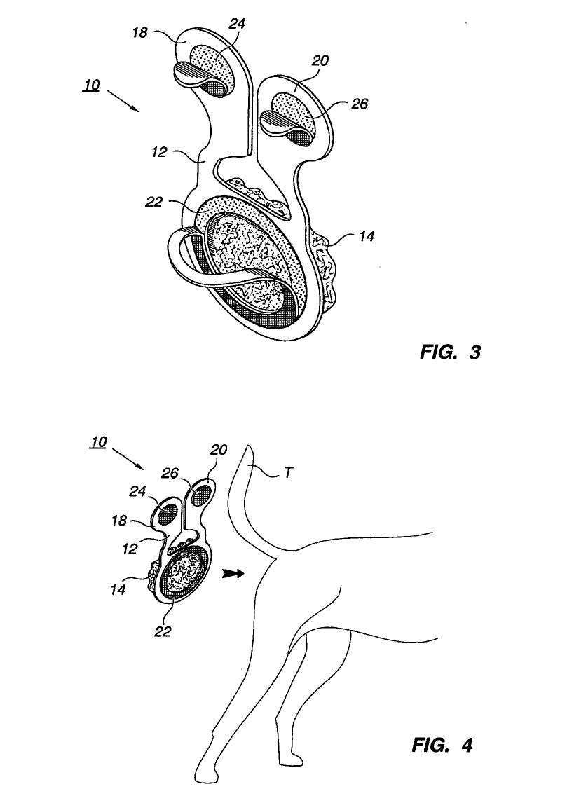

Using the invention proceeds as follows. At the preparatory stage depicted in FIG. 3, the protective skin of the patches 22, 24 and 26 are peeled off to expose the sticky surfaces thereof. The device is then mounted to the dog (FIG. 5) so that its tail T extends between the roots of the flaps 18 and 20, and each of patches 22, 24 and 26 become adhered to the fur of the dog and are so retained.

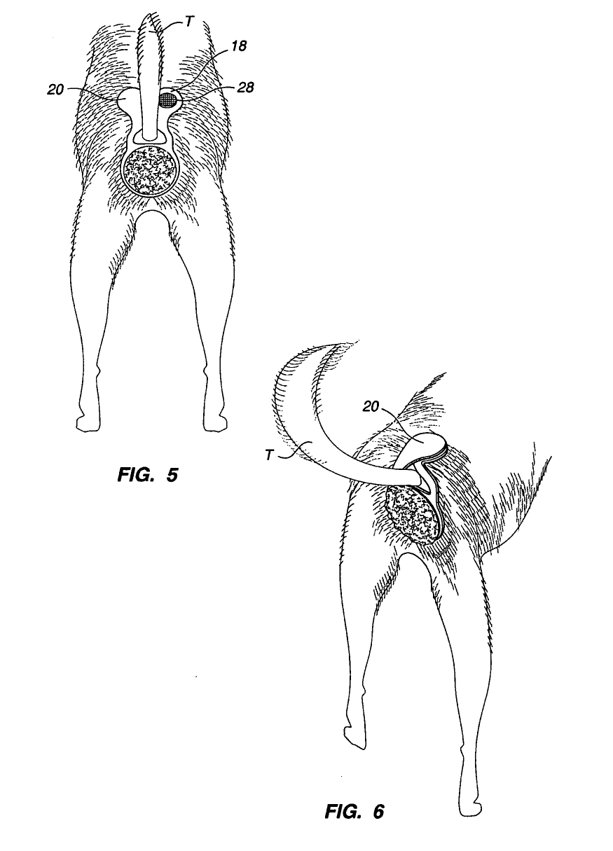

Alternatively, the patch 26 of the flap 20 can be attached to the second, back-side patch 28 of the flap 18 as seen in FIG. 6.

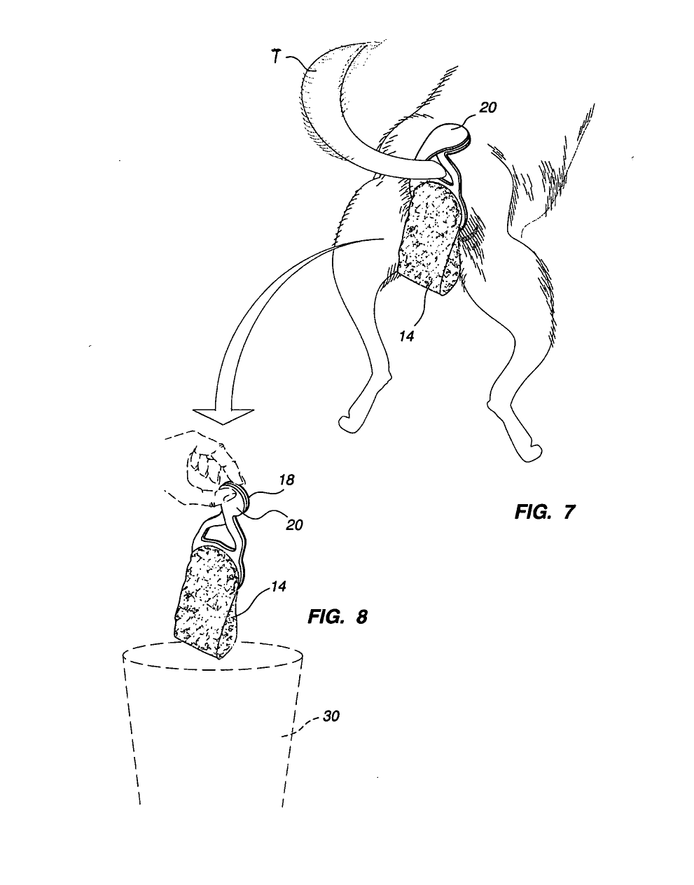

When the dog bends down to deposit its droppings (FIG. 7) the loaded waste will cause the bag 14 to become extracted from the previously folded-down state to automatically contain the bulk of waste.

The device 10 is then stripped-off the dog and carried by the flaps 18 and 20 to a nearest garbage bin 30 as shown in FIG. 8.

Hence, whenever taken for a walk, the device must be placed in a position ready to receive the droppings. It is believed that dogs will soon get accustomed to that, the same way as to the leash and mouth muzzle, which are definitely much more annoying.

The invention thus provides a more friendly and aesthetic solution to the problem of keeping the urban public areas less messy.

Numerous variations and modifications of the invention will be readily appreciated by anyone of ordinary skill in the art.

What is claimed is:

1. A portable dogs dropping collection and disposal device comprising:
a carrier member made of a yieldable sheet material parts of which having been removed to define an opening as well as a pair of elongated flaps extending parallel to each other;
a bag made of a foldable sheet material having a mouth portion being attached to one side of the carrier member around the said opening;
a first sticky patch carried at the free end of one of the said flaps facing the side opposite to the bag; and
a second sticky patch carried at the free end of the second flap facing the side opposite to the bag.

2. The device of claim 1 further comprising a sticky patch carried by at-least a part of the opening perimeter facing the side opposite to the bag.

3. The device of claim 1 further comprising a third sticky patch carried at the free end of the second flap facing the side opposite to the second patch.

4. The device of claim 1 wherein the carrier member is made of plastics.

5. The device of claim 4 wherein the sticky patches and the bag mouth are glued to the carrier member.

6. The device of claim 5 wherein the bag is adapted to transform from a crimped, flat position to an unfolded, container position when filled with dog's dropping.

7. The device of claim 6 wherein the sticky patches are normally covered by a protective peel-off layer.

8. The device of claim 6 wherein the sticky patches are of the “Velcro” type.
